(19) United States
(12) Patent Application Publication
(10) Pub. No.: US 2017/0165858 A1
(43) Pub. Date: Jun. 15, 2017

(54) SLICING DEVICE COMPRISING RAPID-MANUFACTURING COMPONENTS

(71) Applicant: GEA Food Solutions Germany GmbH, Biedenkopf-Wallau (DE)

(72) Inventors: Alois Bochtler, Egg (DE); Alexander May, Waltenhofen (DE); Winfried Hörberg, Obergünzburg (DE)

(21) Appl. No.: 15/300,377

(22) PCT Filed: Apr. 8, 2015
(86) PCT No.: PCT/EP2015/000740

§ 371 Date: Sep. 29, 2016

(30) Foreign Application Priority Data
Apr. 9, 2014 (DE) 10 2014 206 826.6

(51) Int. Cl. B26D 7/06; B33Y 80/00; B33Y 10/00; B26D 7/26; B26D 1/00

(52) U.S. Cl. CPC B26D 7/0683; B26D 7/2621; B26D 1/0006; B26D 7/0625; B33Y 10/00; B33Y 80/00; B26D 2001/002; B26D 2007/011

(57) ABSTRACT

The present invention relates to a device (5) for slicing one or more food products (2), especially sausage, ham and/or cheese, wherein for every food product (2) a separate track (7) is provided along which said food product is transported towards a moving blade (11) which separates food slices (12) from the front end of the food product (2).

The present invention relates to a device for slicing one or a plurality of foodstuff product(s), in particular sausage, ham and/or cheese, wherein one dedicated track is provided for each foodstuff product, along which track the latter is transported in the direction of a moving blade which severs foodstuff slices from the front end of the foodstuff product.

Devices of this type are well known in the prior art. However, the devices or methods, respectively, according to the prior art do have the disadvantage that they are comparatively complex to manufacture, or that they have disadvantages in terms of hygiene, respectively.

It has thus been the object of the present invention to provide a method which does not have the disadvantages of the prior art.

The object is achieved by a device for slicing one or a plurality of foodstuff product(s), in particular sausage, ham, and/or cheese, wherein one dedicated track is provided for each foodstuff product, along which track the latter is transported in the direction of a moving blade which severs foodstuff slices from the front end of the foodstuff product, wherein the device has at least one part which is manufactured by the rapid-manufacturing method.

The statements made in the content of this subject matter of the present invention apply in equal measure to the other subjects of the present invention, and vice versa.

The present invention relates to a device for slicing foodstuff products such as, for example, sausage, ham, and/or cheese. Slicing devices of this type are also referred to by a person skilled in the art as a “slicer” or a “heavy duty slicer”. These slicing devices have a moving, in particular rotating, cutter blade which cuts off foodstuff slices from the front end of a foodstuff product. The emitter blade herein, rotates at up to 1000 revolutions per minute and beyond, and/or interacts with a cutting edge which is provided at the front end of a product support, for example, and which, together with the blade, defines the cutting plane in which foodstuff slices are severed from the foodstuff product. A cutting gap which is to be as small as possible so as to prevent “chopping” of parts of the foodstuff product is located between the cutter blade and the cutting strip. However, the cutting gap must be sufficiently large in order for the blade as far as possible not to contact the cutting edge. The foodstuff product during slicing is continuously or intermittently transported in the direction of the cutter blade. Once a slice has been cut off from the respective foodstuff product, the cutter blade disengages from the respective foodstuff product, so as thereupon again to penetrate into the foodstuff product and to cut off the next foodstuff slice. Indexing of the respective foodstuff product between two cuts determines the thickness of the respective foodstuff slice being cut off. The foodstuff slices having been cut off drop onto a placing table, for example, on which they are gathered to form portions. As soon as one portion has been completed, the latter is removed from the drop zone of the blade, and slicing of a new portion may commence. The slicing device is preferably provided having multiple tracks, i.e. so that a plurality of foodstuff products are in particular at least in part simultaneously, or at least in part sequentially, sliced by one blade. To this end, the device has a dedicated track for each foodstuff product, along which track the latter is transported in the direction of the blade.

According to the invention, the device now has at least one part which is manufactured by the rapid-manufacturing method. The latter here is a primary shaping method in which a layer of a pulverulent and/or free-flowing substance, for of a plastics substance, a metal, a metal alloy, and/or a ceramics material, is dispensed by an application device, for example by a printer, according to a specific pattern, and the component parts of the layer thereafter are interconnected and/or connected to the layer therebelow. Connecting herein may be performed, for example, by way of the influence of heat, pressure, evaporation/volatilization of a solvent, and/or by cross-linking a plastics material. In this way, a three-dimensional complex component may be constructed. For a person skilled in the art it was extremely surprising and unexpected that parts of this type, despite the very high stress levels which arise when slicing foodstuffs in particular using heavy-duty slicers, have proven suitable for slicing devices. Moreover, it was unexpected that components which are manufactured by a rapid-manufacturing method have met or even exceeded, respectively, the hygienic requirements that are set for foodstuff-processing machines.

Those parts that nave been manufactured by the rapid-manufacturing method preferably do not have any blind holes. Temperature control, in particular cooling, of these parts is preferably improved in comparison to components manufactured by casting, injection-molding, and/or subtractive machining, for example. Preferably, the parts are provided such that any cleaning liquid after cleaning runs off completely, preferably by means of the force of gravity. The same preferably applies to any cooling liquid.

According to one further subject matter of the invention, or to a preferred subject matter of the present invention, respectively, at least one part of the slicing device is manufactured by way of a layered construction from a pulverized, or free-flowing material.

The parts are preferably composed of different materials, wherein the material may vary per layer and/or within one layer. Different materials in the context of the invention does not only relate to different substances but optionally also to different particles sizes or the distribution of particle sizes.

That part that is manufactured by the rapid-manufacturing method or is manufactured in a layered construction from a pulverized or free-flowing material, respectively, is preferably a product gripper which grips the foodstuff product at the rear end thereof that is opposite the cutting plane, in particular stabilizing the foodstuff product in the positions of the latter toward the end of slicing, or disposing of the end piece, respectively. The gripper preferably has gripping tongs which for the purpose mentioned above bury themselves in the foodstuff product. Particularly preferably, these gripping tongs are manufactured by the rapid-manufacturing method, or by way of a layered construction from a pulverized or free-flowing material, respectively. In particular, metal and/or metal-alloy powder and/or ceramics is/are used herein as a material. However, plastics are also a potential material.

According to a further preferred embodiment of the present invention, that part that is manufactured by the rapid-manufacturing method, or by way of a layered construction from a pulverized or free-flowing material, respectively, is a cutting strip which during severing of a foodstuff slice interacts with the cutter blade, so as to achieve as clean a cut as possible, and/or which guides the front end of the foodstuff product during cutting. The cutting strip is preferably provided at the end of the product support and/or together with the cutter bade defines the cutting plan in which the foodstuff slice is severed from the foodstuff product.

Plastics are a preferred material herein. In the case of the slicing device according to the invention being provided for the inclusion of a so-called interleaver between two foodstuff slices, the ejection duct through which the interleaver strip is inserted into the cutting plane and then severed by the cutter blade is provided in the cutting strip, and particularly preferably the duct that guides the interleaver strip during ejection is likewise manufactured by a rapid-manufacturing method, or by way of a layered construction from a pulverized or free-flowing material, respectively. The duct herein is preferably provided such that the planar interleaver strip is undulated and/or bent in the duct.

In the case of some applications there is the desire for the respective foodstuff slice during or post slicing to be modified in the shape thereof, for example to be folded, and/or for the respective foodstuff slice to be modified in terms of the trajectory thereof. To this end, so-called folding devices are provided which are located in the drop zone, usually above a placing table on which the respective portion is established. The foodstuff slice herein may coma into contact with the folding device and/or drop past the latter. The folding device may be provided so as to be static or moving, for example rotating. Furthermore, the folding device may have one or a plurality of outlets through which gas is ejected continuously or intermittently, wherein the air flow generated on account thereof shapes the foodstuff slice and/or modifies the friction between the folding device and the foodstuff slice. Preferably and particularly, flow ducts which impart a specific direction and/or a specific swirl to the gas flows exiting from the outlets are provided upstream of these outlets in each case. By manufacturing the folding device by a rapid-manufacturing method, or by manufacturing the folding device by way of a layered construction from a pulverized or free-flowing material, respectively, it is possible in particular for these ducts to be imparted a store complex shape than is possible in the case of a casting, injection-molding, and/or subtracting machining method. Moreover, blind holes which represent a hygiene issue may be prevented.

According to a further preferred subject matter of the present invention, the cutter blade is at least in part manufactured according to the rapid-manufacturing method, or by way of the layered construction from a pulverized or free-flowing material, respectively. In particular the main body of the blade, i.e. the region between the fastening of the cutter blade to the blade receptacle of the slicing device and the cutting edge, is manufactured according to the rapid-manufacturing method, or by way of the layered construction from a pulverized or free-flowing material, respectively. Preferably, the interior of the main body is at least in part manufactured to be hollow and/or has a reinforcement structure that is constructed in the manner of a honeycomb, for example. The main body is preferably made of metal, a metal alloy, and/or of a plastics material. The cutting edge may be provided integrally on the main body, and, for example, may likewise be manufactured according to the rapid-manufacturing method, or by way of the layered construction from a pulverized or free-flowing material, respectively. However, it is also conceivable for the cutting edge to be manufactured from a cast or rolled steel and then to be connected to the main body by way of a form-fit, force-fit and/or a form-fit. The cutter blade may be a circular blade or a sickle blade for example.

In the case of the slicing device according to the invention, the cutter blade is driven by a so-called rotor which rotatingly drives said cutter blade and optionally also moves the latter along an orbital path, so as to disengage a circular blade from the foodstuff product, for example. The rotor is preferably at least in part manufactured according to the rapid-manufacturing method, or by way of the layered construction from a pulverized or free-flowing material, respectively. On account thereof, comparatively complex cooling ducts may be installed, for example, and the latter may be routed so as to be closer to the beaming on which a large amount of heat is generated, for example, so that the heat is discharged directly at the point where said heat is generated. On account thereof, the durability of the bearings is enhanced, and maintenance cycles are extended. The ducts may be embodied so as to be free from blind holes. It is also possible for prefabricated parts, for example bearings, to be connected directly to the rotor in a form-fitting, force-fitting, and/or materially integral manner, so as to implement constructions which have not been possible as per current production methods.

The device according to the invention preferably has an indexing carriage for a product gripper which, as has been described above, grips the foodstuff product at the rear end thereof and in particular stabilized said food product in the position thereof once slicing has already progressed far. The indexing carriage serves for moving the gripper to and fro, in the direction toward the food product and away from the cutter blade. Preferably, this indexing carriage is now at least in least in part manufactured according to the rapid-manufacturing method, or by way of the layered construction from a pulverized or free-flowing material, respectively.

According to a further preferred subject matter of the present invention, a sheet-metal underlay tray of a placing table is manufactured according to the rapid-manufacturing method, or by way of the layered construction from a pulverized or free-flowing material, respectively. After slicing, the foodstuff slices drop onto this placing table and are there configured to form portions of a plurality of foodstuff slices. These placing tables typically have at least one transportation belt or a transportation tapes onto which the foodstuff slices drop. The sheet-metal underlay tray supports the transportation belt or the transportation tapes, respectively, preventing said belt or said tapes from excessively yielding in particular in the case of the first foodstuff slices of a portion.

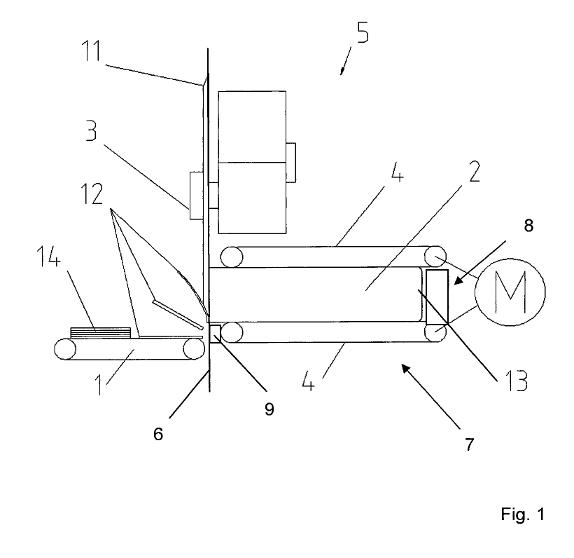

The invention will be explained hereunder by means of FIGS. 1 to 8. These explanations are purely exemplary and do not limit the general concept of the invention. The explanations apply in equal measure to all subjects of the present invention.

FIG. 1 shows the slicing device according to the invention;

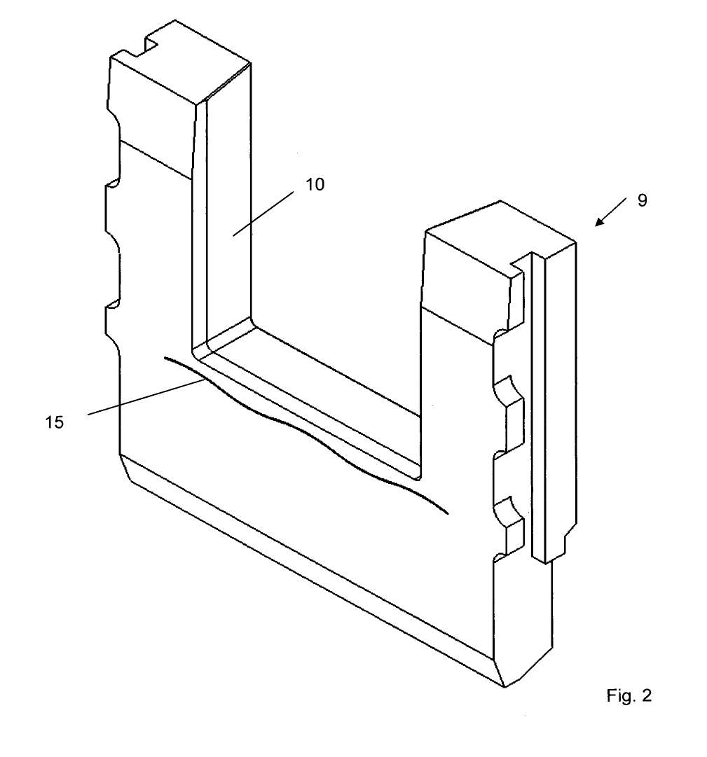

FIG. 2 shows the cutting strip of the slicing device, according to the invention;

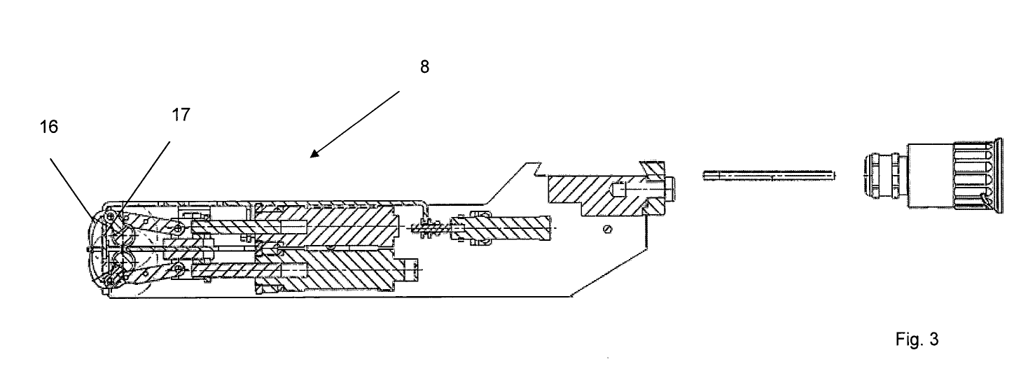

FIG. 3 shows the gripper of the slicing device, according to the invention;

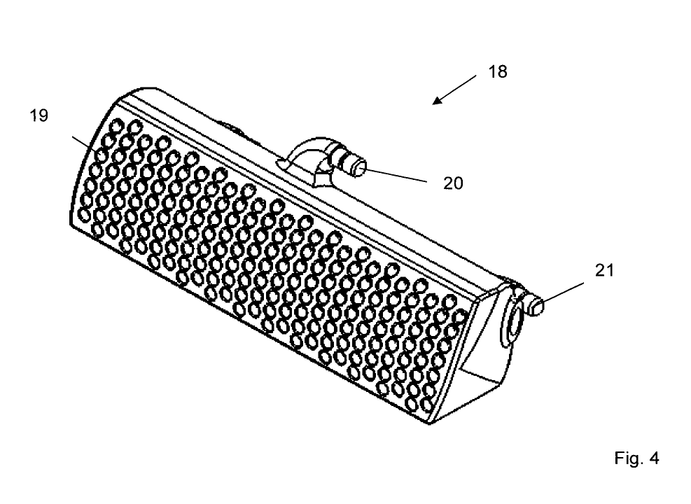

FIG. 4 shows the folding device of the slicing device, according to the invention;

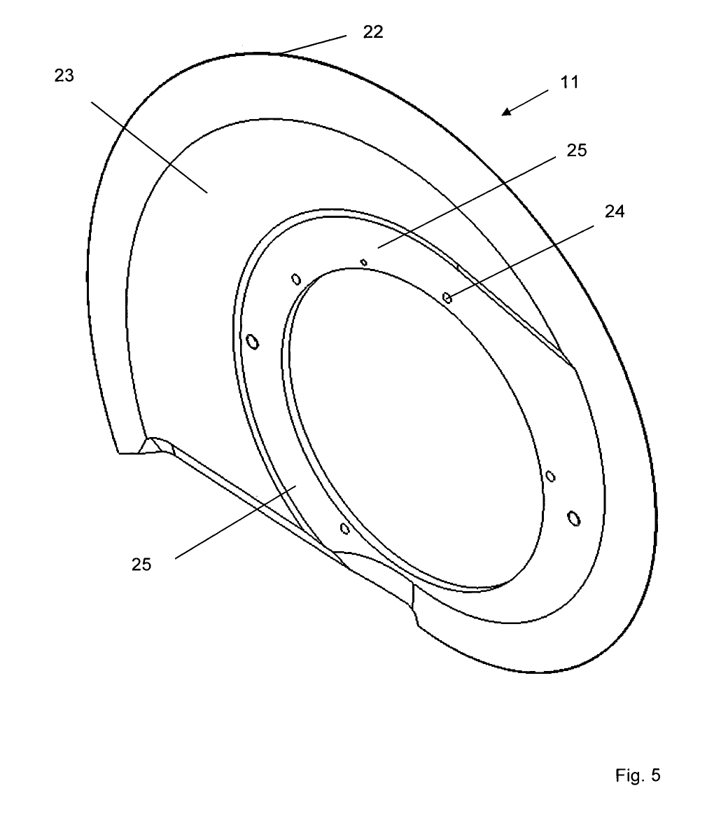

FIG. 5 shows the cutter blade of the slicing device, according to the invention;

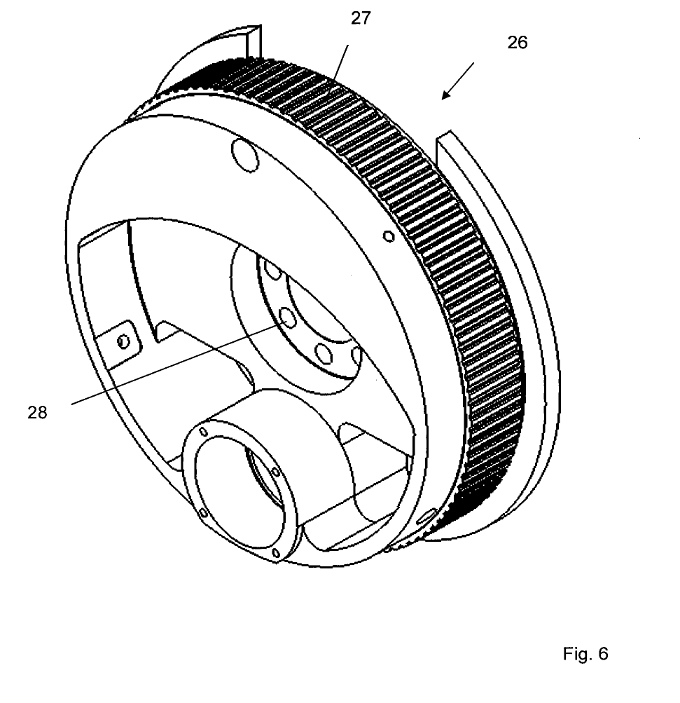

FIG. 6 shows the rotor of the slicing device, according to the invention;

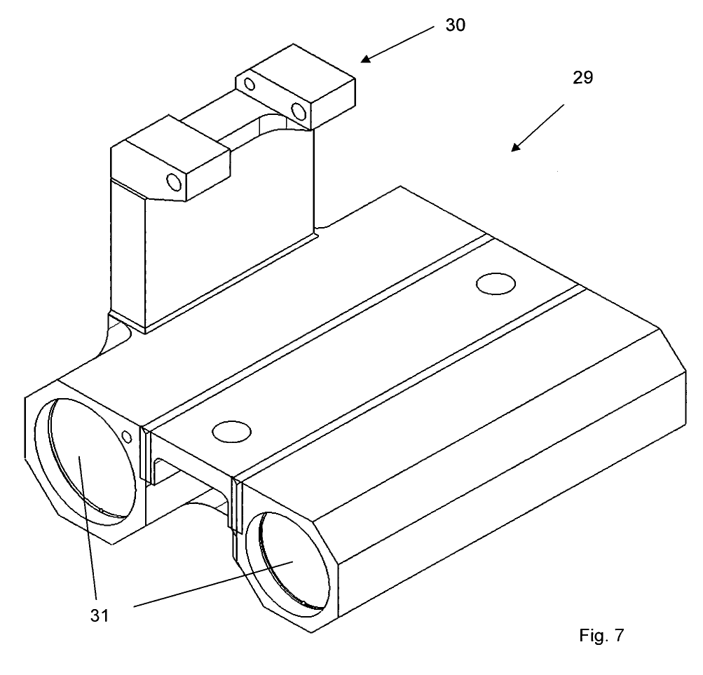

FIG. 7 shows the gripper carrier of the slicing device, according to the invention;

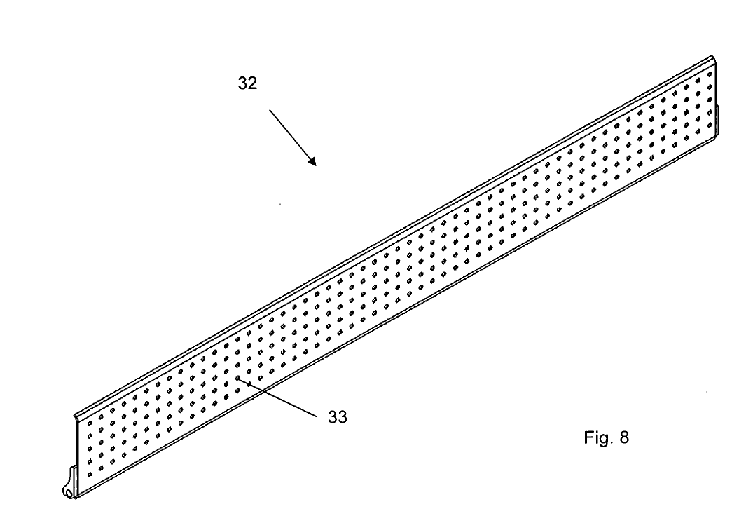

FIG. 8 shows the sheet-metal underlay tray according to the invention.

FIG. 1 shows a slicing device 5. The slicing device 5 has a cutter blade 11 which cuts a foodstuff product 2 into foodstuff slices 12. To this and, each foodstuff product 2 by way of a conveying means 4, presently two conveyor belts 4, is continuously or intermittently transported in the direction of the cutting plane 6 of the blade 11. The lower conveyor belt 4 is simultaneously a product support. The cutter blade 11 is fastened to a rotating blade receptacle 3 and in a cutting manner interacts with a cutting edge 9 which is provided at the front end of a product support 4, for example, together with the latter defining the cutting plane 6. A so-called cutting gap which is to be as small as possible but has to be sufficiently large for the blade not to contact the cutting edge is present between the blade 11 and the cutting edge 9. This gap has to be regularly set. This may be performed by moving the blade and/or the cutting edge. Moreover, the cutting edge must be aligned so as to be parallel with the blade. After slicing, the foodstuff slices typically drop onto a placing table 1 which is provided with transportation means, for example a transportation belt or transportation tapes, on which said foodstuff slices are configured so as to form a respective portion 14, presently a stack. The completed portions 14 are then transported away from the region of the cutter blade and then packed. A sheet-metal underlay tray which in particular prevents excessive elongation of the transportation means may be provided below the transportation means of the placing table. The slice thickness is then a result of the indexing path of the foodstuff product between two cuts. In the case of a constant rotating speed of the blade, regulating the slice thickness is performed by way of the indexing speed of the foodstuff product. The slicing device may have one gripper 8 per indexing lane, which gripper 8 grips the rearward end 13 of the foodstuff product 2 prior to or during slicing, stabilizing the latter during slicing, in particular toward the end of slicing, and disposing of the end piece that cannot be sliced. Each gripper is preferably provided on a gripper carriage (not illustrated) which moves the grippers to and fro, in particular in parallel with the indexing direction of the foodstuff product.

The slicing device is preferably provided having multiple tracks, i.e. so that a plurality of foodstuff products 2 are in particular at least in part simultaneously, or at least in part sequentially, sliced by one blade. To this end, the device for each foodstuff product has a dedicated track 7 along which said foodstuff product is transported in the direction of the blade 11.

FIG. 2 shows a cutting strip 9 which during cutting of the foodstuff product interacts with the cutter blade 11 and has a product guide 10 which in the present case is provided for a rectangular or square product, and guides the product during cutting such that the latter cannot avoid the blade. In the present case, the cutting strip has an interleaver exit duct 15 from which an interleaver strip exits, said interleaver strip being likewise severed by the cutter blade from the interleaver strip and being provided between two foodstuff slices such that the adhesion between the foodstuff slices is reduced. According to the invention, this cutting strip is now manufactured according to the rapid-manufacturing method, or by way of a layered construction, respectively. On account thereof, the interleaver exit duct in particular may have a shape which has not been possible by casting, injection-molding, or a subtractive machining method. The cutting strip is preferably manufactured from a plastics, metal, and/or ceramics material. These materials are preferably applied as a powder and thereafter connected to the material layer therebelow. It has been surprising to a person skilled in the art that, despite a comparatively porous construction of the material, the hygiene required for a foodstuff-processing device is existent.

FIG. 3 shows a further preferred embodiment of the present invention. In the present case, that part that has been manufactured according to a rapid-manufacturing method, or by way of a layered construction, respectively, is the product gripper 8 which is made to connect to the rear end, i.e. that end that faces away from the cutting face, of the foodstuff product 2. In particular, the gripping tongs 16 which are driven into the product as soon as the gripper bears on the rear side of the foodstuff product are manufactured according to the rapid-manufacturing method, or by way of a layered construction, respectively. On account thereof, very complex structures of the gripping tongs, which improve contact between the gripper and the foodstuff product, may be implemented, on account of which the latter in terms of the position thereof may be better stabilized in particular when slicing of the foodstuff products is close to being terminated. Alternatively or additionally, according to a further preferred embodiment of the example, the contact face of the gripper for the foodstuff product is manufactured according to the rapid-manufacturing method, or by way of a layered construction, respectively. On account thereof, contact faces which are individualized for the respective foodstuff product may be manufactured, without expensive tools, in particular casting tools, having to be manufactured. Preferably, the gripper, the gripping tongs and/or the contact face is/are manufactured from a plastics, metal, and/or ceramics material. These materials are preferably applied as a powder and thereafter connected to the material layer therebelow. It has been surprising to a person skilled in the act that, despite a comparatively porous construction of the material, the hygiene and strength required for a foodstuff-processing device are existent.

FIG. 4 shows a further preferred embodiment of the device according to the invention. In the present, case, the device has a so-called folding device 18 which is provided downstream of the cutter blade 11, in particular above the placing table 1. In the present case, the folding device has a gas connector 20 and gas exit ducts, in particular air exit ducts 19, through which gas, presently compressed air, flows, said gas either reducing the adhesion between the folding device and the respective foodstuff slice, and/or modifying the respective foodstuff slice in the shape thereof, for example by folding, or influencing the trajectory of the foodstuff slice. In the present case, the folding device 18 also has a suspension 21 which may be provided so as to be static or dynamic, i.e. the folding device may be stationary or moving, for example rotating. According to the invention, this folding device is now manufactured according to the rapid-manufacturing method, or by way of a layered construction, respectively. On account thereof, the gas exit ducts, in particular, may be designed such that the influence that is to be exerted by the latter on the respective foodstuff slice may be achieved in an optimal manner. In particular, ducts which to date have not been possible by casting, injection-molding, or a subtractive machining method may be manufactured. The folding device is preferably manufactured from a plastics, metal, and/or ceramics material. These materials are preferably applied as a powder and thereafter connected to the material layer therebelow. It has been surprising to a person skilled in the art that, despite a comparatively porous construction of the material, the hygiene required for a foodstuff-processing device is existent.

FIG. 5 shows a cutter blade 11 of the device according to the invention. Said cutter blade 11 has a contact face 25 by way of which the cutter blade is provided on the blade receptacle 3 of the rotor of the slicing device. The cutter blade, preferably by way of fastening means 24, presently clearances which may be penetrated by a screw for example, is fastened to this blade receptacle. The cutter blade furthermore has a main body 23 and a cutting edge 22. The main body 23 and the cutting edge 22 may be provided integrally or be composed of a plurality of mutually interconnected parts. The contact face 25 is typically a part of the main body 23. According to the invention, at least the main body is now manufactured according to the rapid-manufacturing method, or by way of a layered construction, respectively. On account thereof, three-dimensional structures which in the interior are partially hollow and which significantly improve the rigidity of the main body may be manufactured in particular. A plastics, ceramics, and/or metallic material, or a metal alloy, may be considered as potential materials for the rapid-manufacturing method, or for the layered construction, respectively. The cutting edge, likewise by means of rapid manufacturing, or by way of a layered construction, respectively, may be provided on this main body. However, it is conceivable for the cutting edge 22 to be a separate component which is connected to the main body in a form-fitting, force-fitting, and/or materially integral manner. The cutter blade and/or the main body is/are preferably manufactured from a plastics, metal/and/or ceramics material. These materials are preferably applied as a power and thereafter connected to the material layer therebelow. It has been surprising to a person skilled in the art that, despite a comparatively porous construction of the material, the hygiene required for a foodstuff-processing device is existent.

FIG. 6 shows a further embodiment of the device according to the invention. In the present case, the rotor 26 of the device is manufactured by means of rapid manufacturing, or by way of a layered construction, respectively. The clearances into which the fastening means of the cutter blade protrude can toe clearly seen. Furthermore, a sprocket 27 which in the present case represents the drive for the rotor can be seen. The rotor may rotatingly drive the blade and additionally move the latter on an orbital path. By way of the rotor being manufactured by rapid manufacturing, or by way of a layered construction, respectively, it is possible, for example, to provide cooling ducts such that the latter lead to the immediate proximity of those regions in which the heat is generated, i.e. for example in the region of bearings, and for the heat to be discharged therefrom. Furthermore, these cooling ducts may be manufactured so as to be free from blind holes, increasing the hygiene of the rotor. The rotor is preferably manufactured from a plastics, metal, and/or ceramics material. These materials are preferably applied as a powder and thereafter connected to the material layer therebelow. It has been surprising to a person skilled in the art that, despite a comparatively porous construction of the material, the hygiene required for a foodstuff-processing device is existent.

FIG. 7 shows the indexing carriage 29 for the grippers 8. In the present case the indexing carriage has two receptacles 31, each for one gripper 8. The indexing carriage has a connection 30 to a drive, in particular to a linear drive, which moves the grippers in the direction of the ends of the foodstuff products and away from the latter. The indexing carriage in the present case is also manufactured by rapid manufacturing, or by way of a layered construction, respectively. On account thereof, again, more complex structure than is the case in current methods may be manufactured. The indexing carriage is preferably manufactured from a plastics, metal, and/or ceramics material. These materials are preferably applied as a powder and thereafter connected to the material layer therebelow. It has been surprising to a person skilled in the art that, despite a comparatively porous construction of the material, the hygiene required for a foodstuff-processing device is existent.

FIG. 8 shows a support for a portioning belt in the region of the placing table 1, the belt being likewise manufactured by means of a rapid-manufacturing method, or by way of a layered construction, respectively. This support 32 in the present case has clearances 33. This support is preferably manufactured according to the rapid-manufacturing method, or by way of a layered construction, respectively. The support 32 prevents excessive elongation of the transportation belt or of the transportation tapes which are provided in the region of the placing table 1 and which transport the respective completed portion 14 out of the drop zone of the cutter blade, or which are required in order for the respective portion to be configured, respectively, for example for the latter to be fabricated. The support is preferably manufactured from a plastics, metal, and/or ceramics material. These materials are preferably applied as a powder and thereafter connected to the material layer therebelow. It has been surprising to a person skilled in the art that, despite a comparatively porous construction of the material, the hygiene required for a foodstuff-processing device is existent.

### LIST OF REFERENCE SIGNS

1 Placing table
2 Foodstuff product
3 Blade receptacle
4 Support face, transportation means of a track 7
5 Slicing device
6 Gutting plane
7 Track
8 Gripper
9 Cutting strip, cutting edge
10 Product guide
11 Blade, cutter blade, circular blade, sickle blade
12 Foodstuff slices
13 Rear side of the foodstuff product
14 Portion, foodstuff portion
15 Interleaver duct
16 Gripping tongs
17 Contact face for the foodstuff product 2
18 Folding device
19 Gas exit duct
20 Gas connector
21 Suspension
22 Cutting edge of the blade 11
23 Main body of the blade 11
24 Fastening opening
25 Contact face on the blade receptacle
26 Rotor
27 Drive, sprocket
28 Clearances for fastening means for the cutter blade
29 Indexing carriage for the gripper
30 Connection to drive
31 Receptacle for gripper
32 Support for a portioning belt in the region of the placing table 1, sheet-metal underlay tray
33 Clearances

1. A device for slicing one or a plurality of foodstuff products, in particular sausage, ham, and/or cheese, the device comprising:
a cutter blade; and
a dedicated track provided for each of the foodstuff products, along which the foodstuff products are transported in a direction of the moving cutter blade, which serves foodstuff slices from a front end of the foodstuff products,
wherein the device has at least one part that is manufactured by a rapid-manufacturing method, and
wherein the part is a folding device, or is part of the folding device.

2-9. (canceled)

10. The device as claimed in claim 1, wherein the part is a product gripper, or is part of the product gripper.

11. The device as claimed in claim 1, wherein the part is a cutting strip, or is part of the cutting strip.

12. The device as claimed in claim 1, wherein the part is the cotter blade, or is part of the cutter blade.

13. The device as claimed in claim 1, wherein the part is a rotor on which the cutter blade or part of the cutter blade is disposed.

14. The device as claimed in claim 1, wherein the part is an indexing carriage for a gripper or part of a gripper.

15. The device as claimed in claim 1, wherein the part is a sheet-metal underlay tray or part of the sheet-metal underlay tray of a placing table.

16. The device as claimed in claim 11, wherein the cutting strip has an interleaver exit duct from which an interleaver strip exists, the interleaver exit duet is manufactured by the rapid-manufacturing method.

17. The device as claimed in claim 10, wherein the product gripper includes gripping tongs that are driven into the foodstuff products, the gripping tongs are manufactured by the rapid-manufacturing method.

18. The device as claimed in claim 1, wherein the folding device is provided downstream of the cutter blade and above a placing table.

19. The device as claimed in claim 1, wherein the folding device comprises a gas connector and gas exit duets through which gas exists.

20. The device as claimed in claim 12, wherein the cutter blade comprises a cutting edge, the cutting edge is manufactured by the rapid-manufacturing method.

21. The device as claimed in claim 1, wherein the device comprises a support for a portioning belt, the support is manufactured by the rapid-manufacturing method.
